(19) United States
(12) Patent Application Publication
(10) Pub. No.: US 2026/0030585 A1
(43) Pub. Date: Jan. 29, 2026

(54) PROCESSING APPARATUS AND DELIVERY SYSTEM

(71) Applicant: TOYOTA JIDOSHA KABUSHIKI KAISHA, Aichi-ken (JP)

(72) Inventors: Shunta SHIMIZU, Edogawa-ku, Tokyo-to (JP); Ryuichi KUMAI, Yokohama-shi, Kanagawa-ken (JP); Yoshiaki TOYAMA, Sumida-ku, Tokyo-to (JP)

(73) Assignee: TOYOTA JIDOSHA KABUSHIKI KAISHA, Aichi-ken (JP)

(21) Appl. No.: 19/256,153

(22) Filed: Jul. 1, 2025

(30) Foreign Application Priority Data
Jul. 25, 2024 (JP) 2024-119401

(51) Int. Cl. G06Q 10/0832

(52) U.S. Cl. CPC G06Q 10/0832

(57) ABSTRACT

A processing apparatus adapted to enable a worker to appropriately prepare packages based on the characteristics of the respective packages. A processing apparatus according to one aspect of the present disclosure includes: a processing apparatus used for delivering a package from a first shelf disposed at a sender side to a second shelf disposed at a receiver side, the receiver side being a location of a residence of the receiver, the processing apparatus including: an information acquisition unit configured to acquire package information including characteristics information of the package and desired-delivery-time information designated by the receiver; a first generation unit configured to generate preparation start time information for a worker to start preparation for performing housing of the package to be delivered in the first shelf based on the characteristics information of the package and the desired-delivery-time information of the package.

### CROSS REFERENCE TO RELATED APPLICATIONS

This application is based upon and claims the benefit of priority from Japanese patent application No. 2024-119401, filed on Jul. 25, 2024, the disclosure of which is incorporated herein in its entirety by reference.

### BACKGROUND

The present disclosure relates to a processing apparatus and a delivery system.

For example, Patent Literature 1 discloses a package delivery management system provided with sorting means for assigning priority to the delivery order of packages based on at least one of the information on the delivery destination of the respective packages and information on the designated delivery time and sorting the packages according to the assigned priority, delivery plan creating means for creating a plan for delivering the sorted packages, and unmanned delivery means for executing delivery of packages by an unmanned delivery machine based on the created delivery plan.
Patent Literature 1: Japanese Unexamined Patent Application Publication No. 2024-22239

### SUMMARY

The applicant has found the following problems. In the package delivery management system disclosed in Patent Literature 1, it is not possible for a worker to appropriately prepare packages based on the characteristics of the respective packages.

The present disclosure has been made in order to solve the above-described problem and provides a processing apparatus and a delivery system each adapted to enable a worker to appropriately prepare packages based on the characteristics of the respective packages.

According to an aspect of the present disclosure, a processing apparatus used for delivering a package from a first shelf disposed at a sender side to a second shelf disposed at a receiver side, the receiver side being a location of a residence of the receiver, the processing apparatus comprising including:
an information acquisition unit configured to acquire package information including characteristics information of the package and desired-delivery-time information designated by the receiver; and
a first generation unit configured to generate preparation start time information for a worker to start preparation for performing housing of the package to be delivered in the first shelf based on the characteristics information of the package and the desired-delivery-time information of the package.

According to the present disclosure, it is possible to provide a processing apparatus and a delivery system each adapted to enable a worker to appropriately prepare packages according to the characteristics of the respective packages.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a control system of a delivery system according to an embodiment;

FIG. 2 is a diagram showing a state in which a package is delivered from a first shelf to a second shelf in the delivery system according to an embodiment;

FIG. 3 is a flowchart for explaining a flow in which a package is delivered using the delivery system according to an embodiment; and

FIG. 4 is a flowchart for explaining a flow in which a package is delivered using the delivery system according to an embodiment.

### DESCRIPTION OF EMBODIMENTS

Specific embodiments to which the present disclosure is applied will be described hereinafter in detail with reference to the drawings. However, the present disclosure is not limited to the following embodiments. Further, the following descriptions and drawings are simplified as appropriate.

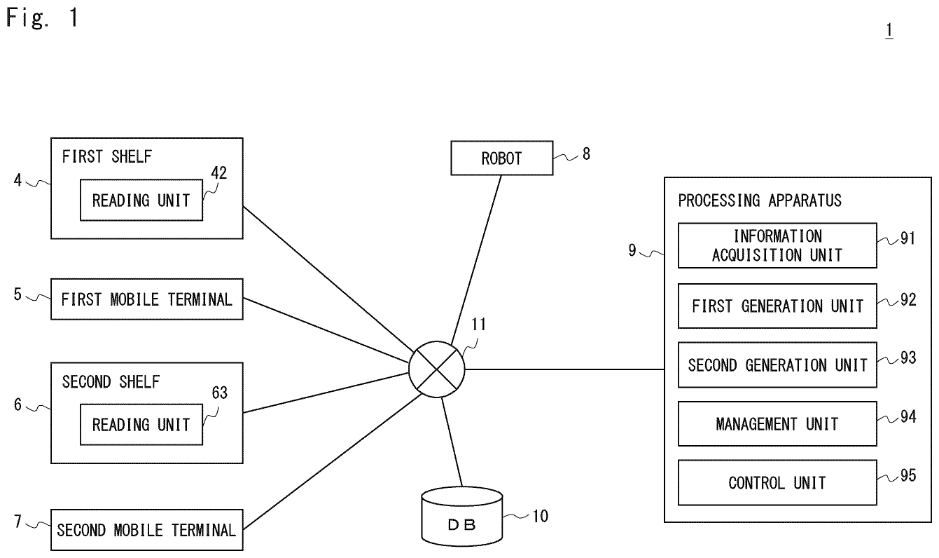

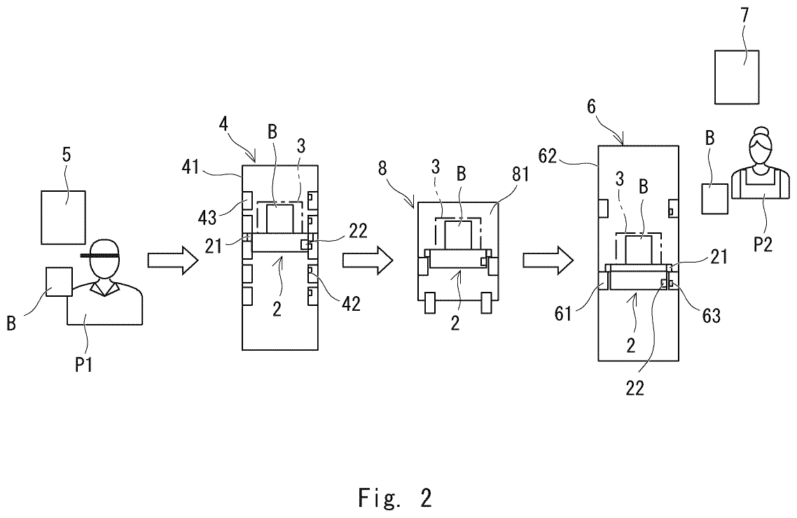

A delivery system according to this embodiment is suitable for delivering a package from a first shelf disposed at a sender side to a second shelf disposed at a receiver side, i.e., at a location of the receiver's residence. FIG. 1 is a block diagram showing a configuration of a control system of a delivery system according to this embodiment. FIG. 2 is a diagram showing a state in which a package is delivered from a first shelf to a second shelf in the delivery system according to this embodiment.

As shown in FIGS. 1 and 2, a delivery system 1 according to this embodiment includes a tray 2, a cold storage box 3, a first shelf 4, a first mobile terminal 5, a second shelf 6, a second mobile terminal 7, a robot 8, a processing apparatus 9, and a database (DB) 10.

The first shelf 4, the first mobile terminal 5, the second shelf 6, the second mobile terminal 7, the robot 8, the processing apparatus 9, and the DB 10 mentioned above are connected through a network 11. The network 11 may be a wired or wireless communication line, for example, the Internet.

As shown in FIG. 2, the tray 2 has, for example, a flat plate shape on which a package B can be placed as its basic form, and a flange 21 protrudes on the side of the tray 2. A tag 22 storing identification information assigned to each tray 2 is provided on the side surface of the tray 2.

The tag 22 may be, for example, an NFC (Near Field Communication) tag whose identification information can be read by a reading apparatus. The tray 2 is, for example, repeatedly used to deliver the package B, and is delivered together with the package B.

As shown in FIG. 2, the cold storage box 3 is, for example, an openable box, and is used for housing and delivering the package B to be delivered in the case where the characteristics information of the package B to be delivered indicates that the package B needs to be kept refrigerated or frozen. The cold storage box 3 may house, for example, an ice pack. The cold storage box 3 is delivered while being placed on the tray 2.

The cold storage box 3 is given identification information including the height information and the cooling property information of the cold storage box 3. The height information of the cold storage box 3 may be, for example, information on the height of the package that can housed in the cold storage box 3 and information about the outer height of the cold storage box 3. The cooling property information of the cold storage box 3 may be, for example, level information indicating cooling levels such as “high”, “medium”, and “low”.

The identification information of the cold storage box 3 may be indicated by, for example, a unique two-dimensional code attached to the cold storage box 3.

The first shelf 4 is disposed at, for example, a delivery base where packages to be delivered are temporarily stored. As shown in FIG. 2, the first shelf 4 includes, for example, a frame 41 and a reading unit 42.

The frame 41 has, for example, a substantially rectangular shape when the frame 41 is viewed from the front thereof as a basic form, and the front and rear surfaces of the frame 41 are opened. As shown in FIG. 2, a plurality of pairs of rails 43 are arranged on the inner surface of the frame 41 at intervals in the up-and-down direction of the frame 41.

The pair of rails 43 extends in the front-rear direction of the frame 41, and supports the tray 2 by the flange 21 of the tray 2 being placed thereon. The plurality of pairs of rails 43 are provided with identification information including height position information of the rails 43 for each pair of the rails 43.

As shown in FIG. 2, the reading unit 42, for example, is fixed to the frame 41 for each pair of rails 43. The reading unit 42 reads the identification information of the tray 2 from the tag 22 when the tray 2 is supported by the pair of rails 43. The reading unit 42 has identification information of the first shelf 4 including the position information thereof and identification information of the rails 43.

The reading unit 42 associates the identification information of the tray 2 that has been read with the identification information of the first shelf 4 and the identification information of the rails 43 supporting the tray 2, and transmits the associated information to the DB 10.

The first mobile terminal 5 is, for example, a mobile terminal owned by worker P1 at a delivery base, who delivers the package B, and is used by the worker P1 to acquire preparation start time information and delivery preparation information from the processing apparatus 9, to start preparing for housing the package B in the first shelf 4 and delivering the package B.

The first mobile terminal 5 is used for inputting the package information of the package B to be delivered, acquiring the identification information of the package B from the processing apparatus 9, reading the identification information of the tray 2 on which the package B is placed, and associating the read identification information of the tray 2 with the identification information of the package B.

The package information of the package B includes, for example, the sender information, the name information, the residence information and the contact information of the delivery destination (receiver), and characteristics information and height information of the package B, and can be acquired by reading a unique two-dimensional code shown or the like shown on a slip attached to the package B by the first mobile terminal 5.

The characteristics information of the package B may be information indicating that the package B needs to be kept refrigerated or frozen, or can be kept at room temperature, for example. The first mobile terminal 5 transmits, to the DB 10, the package information of the package B and the identification information of the tray 2, the identification information of the tray 2 being associated with the identification information of the package B.

The second shelf 6 is disposed, for example, at the residence of a receiver P2 who receives the package B. As shown in FIG. 2, for example, the second shelf 6 has a configuration substantially the same as that of the first shelf 4, and includes a frame 62 in which a plurality of pairs of rails 61 are disposed, and a reading unit 63 disposed in the frame 62 so that it can read the identification information of the tray 2 from the tag 22 of the tray 2 supported by the pair of rails 61.

The reading unit 63 has identification information of the second shelf 6 including the position information thereof and identification information of the rails 61. The reading unit 63 associates the read identification information of the tray 2 with the identification information of the second shelf 6 and the identification information of the rails 61 supporting the tray 2 in the second shelf 6, and transmits the associated information to the DB 10.

The second mobile terminal 7 is, for example, a mobile terminal owned by the receiver P2, and is used to input information on the desired-delivery-time information (hereinafter referred to as desired-delivery-time information) of the package B and the receipt completion information of the package B. The second mobile terminal 7 transmits, to the DB 10, the desired-delivery-time information of the package B and the receipt completion information of the package B.

The desired-delivery-time information of the package B may be set on one hour basis (i.e., one-hour unit), for example. However, according to the characteristics information of the package B, the desired-delivery-time information of the package B may be set on 15 minutes basis (i.e., 15-minute unit) in the case where the characteristics information of the package B indicates that the package B needs to be kept refrigerated or frozen, and may be set by one-hour unit in the case where the characteristics information of the package B indicates that the package B can be kept at room temperature.

In other words, the unit time may be adjusted according to the characteristics information of the package B. The receipt completion information of the package B is input via the second mobile terminal 7 when the receiver P2 has received the package B (i.e., completion of receipt of the package B), for example.

The robot 8 is a mobile body for delivering the tray 2 to and from the first shelf 4 and the second shelf 6 and collecting the tray 2 after the package B has been picked-up from the second shelf 6. As shown in FIG. 2, the robot 8 includes, for example, a housing part 81, and is configured to be able to house the tray 2 from the first shelf 4 to the housing part 81, or to house the tray 2 from the housing part 81 to the second shelf 6 by means of a conveyance mechanism (not shown).

The processing apparatus 9 includes an information acquisition unit 91, a first generation unit 92, a second generation unit 93, a management unit 94, and a control unit 95 as shown in FIG. 1.

The information acquisition unit 91 acquires information from the DB 10 when the first generation unit 92, the second generation unit 93, the management unit 94, and the control unit 95 execute a process described later. The information acquisition unit 91 acquires, from the DB 10, for example, the identification information of the first shelf 4, the usage state information of the first shelf 4, the package information of the package B, the identification information of the package B, the desired-delivery-time information of the package B, the height information of the cold storage box 3, the cooling property information of the cold storage box 3, the identification information of the cold storage box 3, the identification information of the second shelf 6, the usage state information of the second shelf 6, the moving speed information of the robot 8, and the predetermined time information on the time required for the worker P1 to prepare the package B and house it in the first shelf 4.

The first generation unit 92 generates the preparation start time information for the worker P1 to start preparation for performing housing of the package B to be delivered in the first shelf 4 based on the desired-delivery-time information of the package B and the characteristics information of the package B.

The second generation unit 93 generates, based on the residence information of the receiver P2 included in the package of information of the package B, the characteristics information of the package B, and the desired-delivery-time information of the package B, the delivery priority information based on which the robot 8 performs delivery of the package B housed in the first shelf 4.

The management unit 94 performs management of the usage status of the first shelf 4 and the second shelf 6, and generation of the delivery preparation information for preparation for making the worker P1 perform preparation for delivery of the package B based on the preparation start time information generated by the first generation unit 92.

The management unit 94 also performs generation of the control information for controlling the robot 8 configured to deliver the package B based on the delivery priority information generated by the second generation unit 93, and generation of the identification information for the package B based on the package information of the package B. The control unit 95 controls the robot 8 based on the control information generated by the management unit 94.

The DB 10 stores the identification information of the cold storage box 3, the height information of the cold storage box 3, the cooling property information of the cold storage box 3, the identification information of the first shelf 4, the usage state information of the first shelf 4, the identification information of the second shelf 6, the usage state information of the second shelf 6, the reservation information of the second shelf 6, the identification information of the tray 2, the package information of the package B, the identification information of the package B, the receipt completion information of the package B, the desired-delivery-time information of the package B, the delivery priority information of the package B, the moving speed information of the robot 8, and the predetermined time information on the time required for the worker P1 to prepare the package B and house it in the first shelf 4.

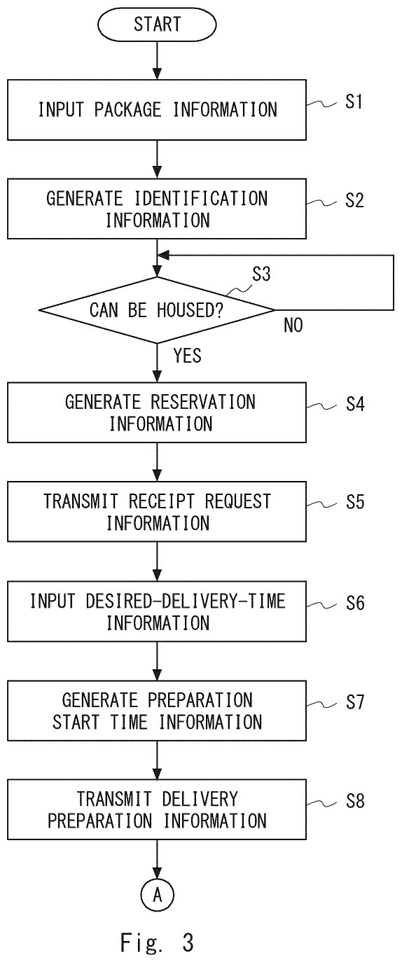

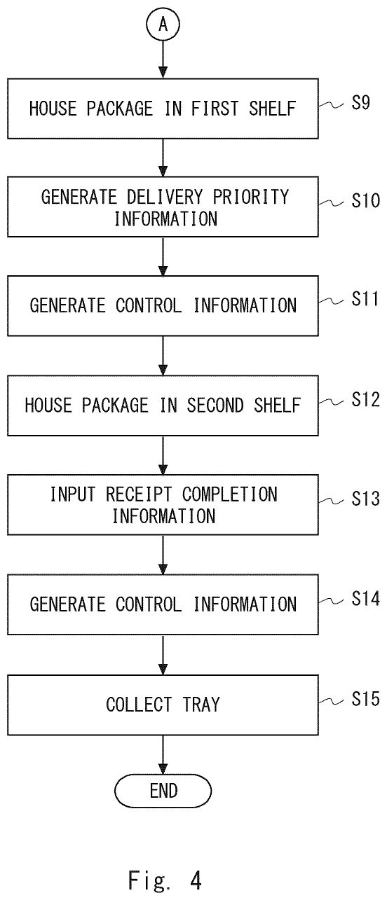

Next, a flow of delivering the package B using the delivery system 1 according to this embodiment will be described. FIGS. 3 and 4 are flowcharts for explaining a flow in which a package is delivered using the delivery system of this embodiment.

Here, the information stored in the DB 10 is acquired as appropriate by the information acquisition unit 91 of the processing apparatus 9 as necessary during each of the following processes (steps). It is assumed that the refrigerated or frozen package B is kept cold in a cold storage.

First, when the worker P1 inputs the package information of the package B via the first mobile terminal 5, the first mobile terminal 5 transmits the package information of the package B to the DB 10 (S1). Then, the management unit 94 of the processing apparatus 9 generates the identification information of the package B associated with the package information of the package B, and transmits the generated identification information of the package B to the first mobile terminal 5 (S2).

Here, in the case where the characteristics information included in the package information indicates that the package B needs to be kept refrigerated or frozen, when the worker P1 inputs the package information of the package B, the management unit 94 of the processing apparatus 9 selects the cold storage box 3 to be used for the delivering the package B based on the height information included in the package information of the package B and the height information of the cold storage box 3, and the height information of the selected cold storage box 3 may be used as the height information of the package B.

Next, the management unit 94 of the processing apparatus 9 determines whether the package B can be housed in the second shelf 6 together with the tray 2 based on the identification information of the second shelf 6, the usage state information of the second shelf 6, and the height information of the package B included in the package information of the package B (S3).

Specifically, the management unit 94 of the processing apparatus 9 generates the usage state information including available space information inside the second shelf 6 based on the identification information of the second shelf 6, the identification information of the package B housed in the second shelf 6, the identification information of the rails 61 supporting the tray 2 housed in the second shelf 6, the identification information of the tray 2 associated with the identification information of the package B housed in the second shelf 6, the package information of the package B associated with the identification information of the package B housed in the second shelf 6, and the receipt completion information.

In the case where the space available on the second shelf as defined by the available space information included in the usage state information of the second shelf 6 is larger than the height of the package of B as defined by the height information of the package B included in the package information of the package B, the management unit 94 of the processing apparatus 9 determines that the package B can be housed in the second shelf 6 (YES in S3). In the case where the package B can be housed in the second shelf 6, the management unit 94 of the processing apparatus 9 generates reservation information for reserving the housing space of the second shelf 6 for housing the package B and the rails 61 into which the tray 2 is inserted, and transmits the generated reservation information to the DB 10 (S4).

On the other hand, the management unit 94 of the processing apparatus 9 determines that the package B cannot be housed in the second shelf 6 in the case where the space available in the second shelf 6 as defined by the available space information included in the usage state information of the second shelf 6 is smaller than the height of the package B as defined by the height information of the package B included in the package information of the package B (NO in S3).

In the case where the package B cannot be housed in the second shelf 6, the management unit 94 of the processing apparatus 9 may, for example, send to, the second mobile terminal 7 owned by the receiver P2, a message urging the receiver P2 of the package B to receive (i.e., pick-up) the package B that has not been received (picked-up) at the second shelf 6.

Then, for example, in the case where the receipt completion information of the package B is transmitted from the receiver P2 via the second mobile terminal 7 and the tray 2 on which the package B is placed is collected by the robot 8, the management unit 94 of the processing apparatus 9 repeats the process from S3. Such repeating of the process is continued until the reservation can be made.

Next, the management unit 94 of the processing apparatus 9 generates receipt request information indicating that there is the package B to be delivered based on the contact information of the receiver P2 included in the identification information of the package B and the package information of package B, and transmits the generated information to the second mobile terminal 7 of the receiver P2 who is to receive the package B (S5).

Then, when the receiver P2 confirms the notification that there is the package B to be delivered (i.e., the package B to be received by the receiver P2) via the second mobile terminal 7 and inputs the desired-delivery-time information of the package B via the second mobile terminal 7, the second mobile terminal 7 associates the desired-delivery-time information of the package B with the identification information of the package B and transmits the associated information to the DB 10 (S6).

Next, the first generation unit 92 of the processing apparatus 9 associates the preparation start time information for the worker P1 to start preparation for performing housing of the package B to be delivered in the first shelf 4 with the identification information of package B and generates the associated information based on the identification information of the first shelf 4, the desired-delivery-time information of the package B, the identification information of the package B, the residence information of the receiver P2 and the characteristics information of the package B included in the package information of the package B, the moving speed of the robot 8, and the predetermined time information on the time required for the worker P1 to prepare the package B and house the package B in the first shelf 4, and then transmits the generated associated information to the DB 10 (S7).

The first generation unit 92 of the processing apparatus 9 performs backward calculation with respect to the desired-delivery-time information of the package B by adding the predetermined time required for the worker P1 to prepare and house the package B in the first shelf 4 to the time required for the robot 8 to move from the first shelf 4 to the second shelf 6 based on the moving speed of the robot 8 and the distance between the first shelf 4 and the second shelf 6 to thereby generate the preparation start time information, but in the case where the characteristics information of the package B indicates that the package B needs to be kept refrigerated or frozen, it is preferable that the package B is kept cold in the cold storage until just before being housed in the first shelf 4.

Therefore, in the first generation unit 92 of the processing apparatus 9, for example, when the characteristics information of the package B indicates that the package B needs to be kept refrigerated or frozen, the time immediately preceding the backward-calculated time may be set as the preparation start time so that the package B is housed in the cold storage until just before the backward-calculated time.

On the other hand, in the first generation unit 92 of the processing apparatus 9, for example, in the case where the characteristics information of the package B indicates that the package B can be stored at room temperature, the time brought forward with respect to the backward-calculated time may be set as the preparation start time so that the worker P1 has enough time with respect to the back-calculated time to perform preparation. Thus, in the case where the characteristics information of the package B indicates that the package B needs to be kept refrigerated or frozen, it is possible to shorten the time for leaving the package B at room temperature.

Here, in the case where the characteristics information of the package B indicates that the package B needs to be kept refrigerated or frozen, the first generation unit 92 of the processing apparatus 9 may generate, taking into consideration the cooling property information of the cold storage box 3, the preparation start time information. Specifically, in the case where a plurality of cold storage boxes 3 are used as the delivery system 1, for example, although there are differences in the cooling property of the respective cold storage boxes 3, it is preferable that the package B be housed in the cold storage until just before the backward-calculated time since the cooling property of the cold storage box 3 becomes lower.

Therefore, based on the cooling property information of the selected cold storage box 3, when the cooling level of the cold storage box 3 indicated in the cooling property information is “high,” the first generation unit 92 of the processing apparatus 9 may set a time earlier than the back-calculated time as the preparation start time compared to the case where the cooling level is “medium” or “low”.

Furthermore, based on the cooling property information of the selected cold storage box 3, when the cooling level of the cold storage box 3 indicated in the cooling property information is “medium,” the first generation unit 92 of the processing apparatus 9 may set a time close to the back-calculated time compared to the case where the cooling level is “high” and earlier than the back-calculated time compared to the case where the cooling level is “low” as the preparation start time. Thus, even in the case where the cooling property of the cold storage box 3 is low, the temperature rise of package B can be suppressed.

Next, the management unit 94 of the processing apparatus 9 generates information by associating the delivery preparation information for making the worker P1 perform preparation for delivery of the package B with the identification information of the package B and transmits the generated information to the first mobile terminal 5 (S8). The delivery preparation information includes preparation start time information.

The worker P1 confirms the delivery preparation information via the first mobile terminal 5 and at the time specified by the preparation start time information, the worker P1 starts preparation of the package B by placing it on the tray 2 and inserting the tray 2 on which the package B is placed into the rails 43 of the first shelf 4 to make them support the tray (S9). Thus, the tray 2 on which the package B is placed is housed in the first shelf 4.

At this time, the worker P1 associates the identification information of the tray 2 obtained by reading the tag 22 of the tray 2 via the first mobile terminal 5 with the identification information of the package B and then houses the tray 2 in the first shelf 4. The first mobile terminal 5 transmits the identification information of the tray 2 associated with the identification information of the package B to the DB 10.

The reading unit 42 of the first shelf 4 reads the identification information of the tray 2 and transmits the identification information of the tray 2, the identification information of the first shelf 4, and the identification information of the rails 43 supporting the tray 2 in the first shelf 4 to the DB 10.

The management unit 94 of the processing apparatus 9 generates the usage state information of the first shelf 4 substantially similar to the usage state information of the second shelf 6, updates the usage state information including the available space information inside the first shelf 4 based on the identification information of the first shelf 4, the identification information of the package B housed in the first shelf 4, the identification information of rails 43 supporting the tray 2 housed in the first shelf 4, the identification information of the tray 2 associated with the identification information of the package B housed in the first shelf 4, and the package information of the package B associated with the identification information of the package B housed in the first shelf 4, and transmits the updated usage state information to the DB 10.

In the case where the characteristics information of the package B indicates that the package B needs to be kept refrigerated or frozen, the worker P1 houses the package B in the cold storage box 3 and houses the storage box 3 in the first shelf 4, but the identification information of the selected cold storage box 3 may be included in the delivery preparation information and transmitted by the management unit 94 of the processing apparatus 9 to the first mobile terminal 5.

Then, the worker P1 may check the selected cold storage box 3 via the first mobile terminal 5, houses the package B in the cold storage box 3, and houses the cold storage box 3 placed on the tray 2 in the first shelf 4. Thus, workability of the worker P1 to house the package B in the first shelf 4 can be improved.

Next, the second generation unit 93 of the processing apparatus 9 generates, based on the identification information of the first shelf 4, the identification of the package B, the residence information of the receiver P2 (i.e., the identification information of the second shelf 6) and the characteristics information of the package B included in the package information of the package B, and the desired-delivery-time information of the package B, the delivery priority information based on which the robot 8 performs delivery of the package B which has been housed in the first shelf 4 and transmits the generated information to the DB 10 (S10).

For example, in the case where a plurality of packages B are housed in the first shelf 4, a refrigerated or frozen package B should be delivered from the first shelf 4 earlier than a package B which can be kept at room temperature. Therefore, the second generation unit 93 of the processing apparatus 9 may generate delivery priority information so that even in the case where the desired-delivery-time information of a package B is the same as the desired-delivery-time information of another package B and the distance between the first shelf 4 and the second shelf 6 (i.e., the delivery distance of each package B) is approximately equal, the package B whose characteristics information indicates that the package B needs to kept refrigerated or frozen is delivered preferentially.

At this time, the second generation unit 93 of the processing apparatus 9 may generate the delivery priority information taking into consideration the cooling property information of the cold storage box 3. For example, the delivery priority information may be generated so that packages are delivered preferentially as the cooling level indicated in the cooling property information of the respective cold storage boxes 3 lowers.

Next, the management unit 94 of the processing apparatus 9 generates control information based on which the robot 8 performs delivery of the package B from the first shelf 4 to the second shelf 6 based on the identification information of the package B, the identification information of the first shelf 4, the identification information of the rails 43 supporting the tray 2 on which the package B is placed in the first shelf 4, the identification information of the second shelf 6, the identification information of the reserved rails 61 included in the reservation information of the second shelf 6, and the delivery priority information (S11).

Next, the control unit 95 of the processing apparatus 9 controls the robot 8 based on the control information. The robot 8 takes out the tray 2 on which the package B is placed from the first shelf 4 and houses it in the housing part 81. Then, the robot 8 moves to the second shelf 6, takes out the tray 2 on which the package B is placed from the housing part 81, and inserts it into the reserved rails 61 of the second shelf 6 to make them support the tray 2 (S12).

Thus, the package B can be delivered from the first shelf 4 to the second shelf 6. At this time, in the case where the characteristics information of the package B indicates that the package B needs to be kept refrigerated or frozen, the package B is delivered in a state of being housed in the cold storage box 3.

Accordingly, the temperature rise of the package B can be suppressed. The management unit 94 of the processing apparatus 9 updates the usage state information of the first shelf 4 and transmits the updated state information of the first shelf 4 to the DB 10.

The reading unit 63 of the second shelf 6 reads the identification information of the tray 2, and transmits the identification information of the tray 2, the identification information of the second shelf 6, and the identification information of the rails 61 supporting the tray 2 of the second shelf 6 to the DB 10. Thus, the management unit 94 of the processing apparatus 9 updates the usage state information of the second shelf 6 and transmits the updated usage state information of the second shelf 6 to the DB 10.

Then, the management unit 94 of the processing apparatus 9 generates delivery completion information indicating that the package B has been delivered to the second shelf 6 based on the contact information of the receiver P2 included in the package information of the package B, and transmits the generated delivery completion information to the second mobile terminal 7 of the receiver P2.

When the receiver P2 receives (picks-up) the package B from the second shelf 6 and then inputs the receipt completion information of the package B via the second mobile terminal 7, the management unit 94 of the processing apparatus 9 updates the usage state information of the second shelf 6 and transmits the updated usage state information to the DB 10 (S13).

Then, the management unit 94 of the processing apparatus 9 generates control information for having the robot 8 collect (pick-up) the tray 2 from the second shelf 6 and place (drop-off) the tray on the first shelf 4 based on the identification information of the package B, the identification information of the first shelf 4, the usage state of the first shelf 4, the identification information of the tray 2 on which the package B was placed, the identification of the second shelf 6, and the identification of the rails 61 that support the tray in the second shelf 6 (S14).

Next, the control unit 95 of the processing apparatus 9 controls the robot 8 based on control information. The robot 8 takes out the tray 2 from the second shelf 6 and houses it in the housing part 81. Then, the robot 8 moves to the first shelf 4, takes out the tray 2 from the housing part 81, inserts it into the available rails 43 of the first shelf 4 to be supported by the rails 43, and the delivery work of the package B ends (S15). At this time, in the case where the characteristics information of the package B indicates that the package B needs to be kept refrigerated or frozen, it is preferable that the tray 2 be collected together with the cold storage box 3 in which the package B was housed.

Thus, the delivery system 1 and the processing apparatus 9 according to this embodiment generate preparation start time information for the worker P1 to start preparation for housing the package B in the first shelf 4 in order to deliver the package B based on the desired-delivery-time information of the package B and the characteristics information of the package B. Therefore, the worker P1 can appropriately prepare the package B while suppressing degradation in the characteristics of the package B.

Furthermore, the delivery system 1 and the processing apparatus 9 of this embodiment generate the delivery priority information based on which the robot 8 performs delivery of the package B which has been housed in the first shelf 4, based on the identification information the first shelf 4, the identification information of the package B, the residence information of the receiver P2 who receives the package B and the characteristics information of the package B included in the package information of the package B, and the desired-delivery-time information of the package B.

Therefore, for example, a refrigerated or frozen package B can be preferentially delivered even in the case where the desired-delivery-time information of a plurality of packages B indicate that the respective delivery times are in the same time zone and the distance between the first shelf 4 and the second shelf 6 is approximately equal. Thus, it is possible to suppress postponement in the delivery of a refrigerated or frozen package B with respect to the desired-delivery-time, whereby rise in the temperature of the package B can be suppressed.

Furthermore, in the case where the delivery system 1 and the processing apparatus 9 according to this embodiment generate the preparation start time information or the delivery priority information of a package B by taking into consideration the cooling property information of the cold storage box 3, rise in the temperature of the package B can be suppressed even when the cooling characteristics of the cold storage box 3 is low.

In the above embodiment, the package B is delivered by the robot 8, but the package B may be delivered by a delivery person.

In the above embodiment, the package information of the package B is input and the identification information of the tray 2 is read and associated with the identification information of the package B through the first mobile terminal 5 but inputting information and associating the information with other information may be performed, for example, through an input device disposed near the first shelf 4. In the above embodiment, the worker P1 acquires various kinds of information through the first mobile terminal 5, but it may be acquired through a display device disposed near the first shelf 4.

In the above embodiment, the desired-delivery-time information of the package B or the receipt completion information of the package B is input through the second mobile terminal 7, but it may be input through an input device disposed near the second shelf 6.

In the description of the flow of delivering the package B in the above embodiment, the process of collecting the tray 2 from the second shelf 6 to the first shelf 4 by the robot 8 is explained, but it may be omitted.

In the above embodiment, the package B is delivered using the tray 2, but the package B may be delivered using a delivery box having a cold-storage function, in which case use of the tray 2 may be eliminated. In this case, the delivery box may be provided with the identification information and supported by the rails 43 of the first shelf 4 and the rails 61 of the second shelf 6.

In the above embodiment, the management unit 94 of the processing apparatus 9 selects the cold storage box 3, but the worker P1 may select the cold storage box 3 depending on the package B, and the identification information of the cold storage box 3 selected via the first mobile terminal 5 may be associated with the identification information of the package B and transmitted to the DB 10.

Part or all of the above processing may be executed by a computer program.

The program includes instructions (or software code) for causing the computer to perform one or more functions described in the embodiments when read into the computer. The program may be stored in a non-transitory computer-readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A processing apparatus used for delivering a package from a first shelf disposed at a sender side to a second shelf disposed at a receiver side, the receiver side being a location of a residence of the receiver, the processing apparatus comprising:
an information acquisition unit configured to acquire package information including characteristics information of the package and desired-delivery-time information designated by the receiver; and
a first generation unit configured to generate preparation start time information for a worker to start preparation for performing housing of the package to be delivered in the first shelf based on the characteristics information of the package and the desired-delivery-time information of the package.

2. The processing apparatus according to claim 1, further comprising:
a second generation unit configured to generate delivery priority information based on which the robot performs delivery of the package which has been housed in the first shelf, generation of the delivery priority information being performed based on residence information of the receiver included in the package information, the characteristics information of the package, and the desired-delivery-time information of the package; and
a control unit configured to control the robot based on the delivery priority information.

3. The processing apparatus according to claim 2, wherein
the characteristics of the package includes keeping the package refrigerated, frozen, or at room temperature;
the information acquisition unit is configured to acquire, when delivering a package that needs to be kept refrigerated or frozen, cooling property information of a cold storage box that houses the package to be delivered; and
the first generation unit is configured to generate preparation start time information of the package, taking into consideration the cooling property information of the cold storage box.

4. The processing unit according to claim 3, wherein the second generation unit is configured to generate delivery priority information based on which the package is delivered, taking into consideration the cooling characteristics information of the cold storage box.

5. A delivery system comprising:
the processing apparatus according to claim 1; and
a robot for delivering the package from the first shelf to the second shelf.
